(19) United States
(12) Patent Application Publication
(10) Pub. No.: US 2026/0264762 A1
(43) Pub. Date: Sep. 10, 2026

(54) EXTERIOR A-PILLAR GARNISH HINGE BRACKET MOUNTING

(71) Applicant: Honda Motor Co., Ltd., Tokyo (JP)

(72) Inventors: Timothy J. RUPP, Dublin, OH (US); Juan Antonio VELA GONZALEZ, Monterrey (MX); Douglas R. KALTENMARK, Powell, OH (US)

(21) Appl. No.: 19/072,505

(22) Filed: Mar. 6, 2025

(51) Int. Cl. B62D 25/04; B62D 25/12

(52) U.S. Cl. CPC B62D 25/04; B62D 25/12

(57) ABSTRACT

A vehicle assembly includes a vehicle body including an A-pillar having an outer side panel, and a lower frame component located forward of the A-pillar in a longitudinal direction of the vehicle body. A garnish covers the A-pillar. A bracket is secured to the lower frame component and spaced forward of the outer side panel. A lower portion of the garnish is secured to the bracket via a first fastener. The first fastener is extended through a hole in the lower portion and fastened to the bracket. The garnish is connected to the outer side panel via at least one second fastener.

### BACKGROUND

It is known to attach a garnish to a vehicle body, for example an A-pillar having an outer side panel, where an outer surface of the garnish defines part of an exterior surface of a vehicle. Typically, clips are provided for attaching the garnish to the outer side panel. While this arrangement is acceptable for certain vehicle models, to meet crash requirements for battery electric vehicles (BEVs) the outer side panel is shortened and cannot support a lower portion of the garnish. Therefore, for BEVs, alternative mounting arrangements are required to secure and support the lower portion of the garnish.

### BRIEF DESCRIPTION

According to one aspect, a vehicle assembly comprises a vehicle body including an A-pillar having an outer side panel, and a lower frame component located forward of the A-pillar in a longitudinal direction of the vehicle body. A garnish covers the A-pillar. A bracket is secured to the lower frame component and spaced forward of the outer side panel. A lower portion of the garnish is secured to the bracket via a first fastener. The first fastener is extended through a hole in the lower portion and fastened to the bracket. The garnish is connected to the outer side panel via at least one second fastener.

According to another aspect, a vehicle assembly comprises a vehicle body including an A-pillar having an outer side panel, and a lower frame component located forward of the A-pillar in a longitudinal direction of the vehicle body. A garnish covers the A-pillar. A lower portion of the garnish is extended at least partially over the lower frame component. A bracket is secured to the lower frame component. The bracket is part of a hinge bracket for an associated vehicle hood. The lower portion of the garnish is secured to the bracket via a first fastener, and the garnish is connected to the outer side panel via at least one second fastener.

According to another aspect, a method of assembling a garnish to a vehicle body including an A-pillar and a lower frame component is provided. The exemplary method comprises attaching a bracket to the lower frame component forward of the A-pillar in a longitudinal direction of the vehicle body; positioning a clip in a clip housing provided on an inner surface of the garnish; attaching the clip to the A-pillar, wherein the garnish is installed normal to a clip axis; and fastening a lower portion of the garnish to the bracket via a bolt installed in one of a width direction and a height direction of the vehicle body.

### BRIEF DESCRIPTION OF THE DRAWINGS

FIG. 1 is a partial perspective view of a known manner for attaching a garnish to an A-pillar of a vehicle body.

FIG. 2 is a partial perspective view of a garnish attached to an A-pillar of a vehicle body of a battery electric vehicle.

FIG. 3 is an enlarged view of FIG. 2 showing one manner for securing and supporting a lower portion of the garnish according to the present disclosure.

FIG. 4 is an enlarged view of FIG. 2 showing another manner for securing and supporting a lower portion of the garnish according to the present disclosure.

FIG. 5 is an enlarged view of FIG. 2 showing another manner for securing and supporting a lower portion of the garnish according to the present disclosure.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as “substantially”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

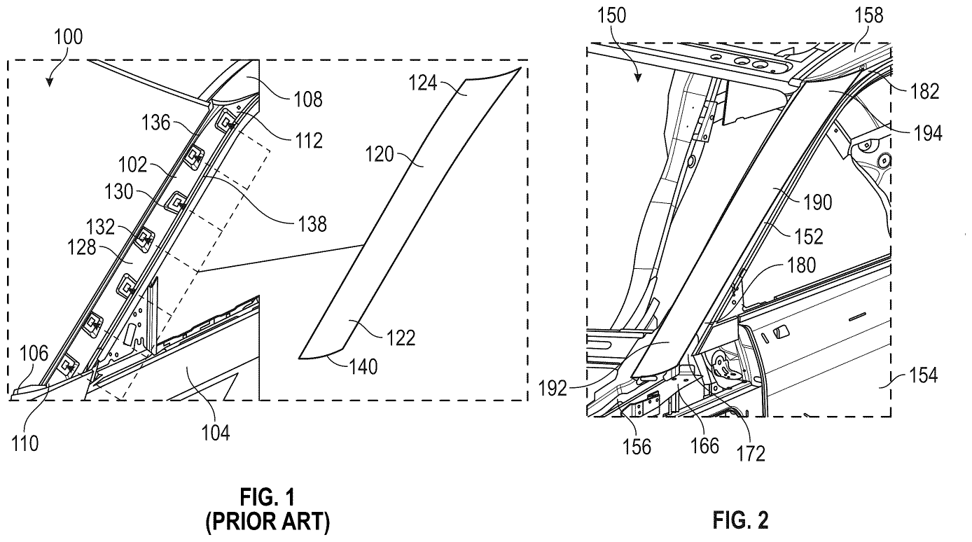

Referring now to the drawings, wherein like numerals refer to like parts throughout the several views, FIG. 1 depicts a known vehicle body 100 including an A-pillar 102, a driver's side door panel 104, a lower frame component 106, and a right roof rail 108. The A-pillar 102 includes a lower portion 110 secured to the lower frame component 106 and an upper portion 112 secured to the right roof rail 108. The lower frame component 106 is forward of the A-pillar 102 in a longitudinal direction of the vehicle body 100. A garnish 120 is mounted to the A-pillar 102, with a lower portion 122 of the garnish 120 covering the lower portion 110 of the A-pillar 102 and an upper portion 124 of the garnish covering the upper portion 112 of the A-pillar. To mount the garnish 120, an outer side panel 128 of the A-pillar includes mounting features 130 having openings 132 that receive fasteners or clips (not shown) provided on an underside (e.g., in clip housings) of the garnish 120. The mounting layout for the garnish 120 is shown in dashed lines in FIG. 1. The mounting features 130 are extended along each side edge portion 136, 138 of the outer side panel 128, with a lowermost mounting feature near the lower frame component 106 and an uppermost mounting feature near the right roof rail 108. With this known manner for attaching the garnish 120 to the side panel outer 128 of the A-pillar 102, the entire garnish 120 from the lower portion 122 to the upper portion 124 is mounted to the outer side panel 128, with a lowermost edge portion 140 of the garnish 120 located immediately adjacent the lower frame component 106. As indicated, this manner is mounting the garnish 120 to the A-pillar 102 acceptable for certain vehicle models.

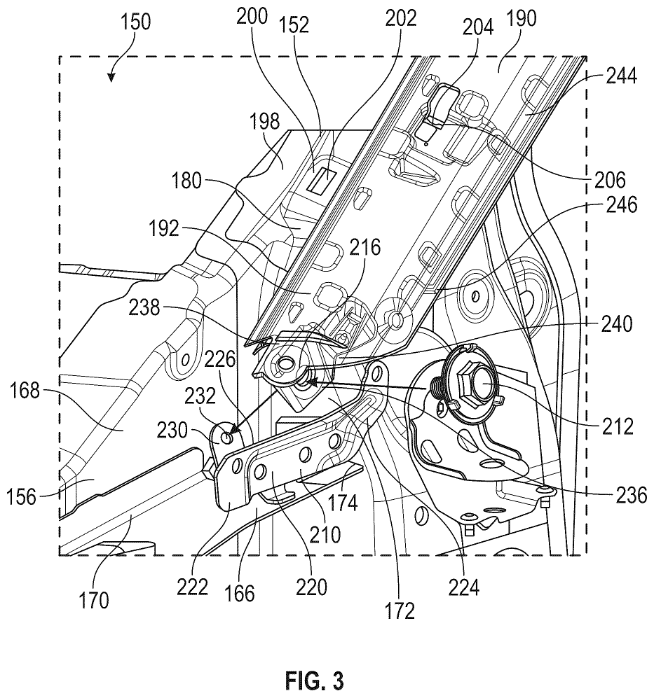

FIGS. 2 and 3 depict a vehicle body 150 for a battery electric vehicle (BEV). The vehicle body 150 includes an A-pillar 152, a driver's side door panel 154, a lower frame component 156, and a right roof rail 158. The lower frame component 156 is forward of the lower portion of the A-pillar 152 in a longitudinal direction of the vehicle body 150 and includes a platform 166 with a vertical wall 168 located inward in a width direction of the vehicle body 150 along an inward side edge 170 of the platform and a vertical wall 172 located rearward in the longitudinal direction along a rearward edge 174 of the platform 166. With this arrangement of the lower frame component 156, the platform 166 is offset from a lower portion 180 of the A-pillar in a height direction of the vehicle body 150. The A-pillar includes the lower portion 180 secured to a part of the lower frame component 156 rearward of the rearward vertical wall 172 and an upper portion 182 secured to the right roof rail 158. This configuration of the A-pillar 152 and lower frame component 156 is required to meet crash requirements for BEVs.

A garnish 190, similar in construction to the garnish 120, includes a lower portion 192 and an upper portion 194. The garnish 190 is mounted to an outer side panel 198 of the A-pillar 152, which includes mounting features 200 having openings 202 that receive fasteners or clips 204 provided on an underside (e.g., in clip housings 206) of the garnish 190. Similar to the outer side panel 128, the mounting features 200 can be extended along each side edge portion of the outer side panel 198, with a lowermost mounting feature near the rearward vertical wall 172 of the lower frame component 106 and an uppermost mounting feature near the right roof rail 158. The upper portion 194 of the garnish 190 covers the upper portion 182 of the A-pillar 152. However, because the outer side panel 198 cannot support the lower portion 192 of the garnish 190 and the lower frame component 156 is configured with the platform 166, the lower portion 192 of the garnish 190 is suspended over the platform without any corresponding supporting structure, which can damage the lower portion 192. Therefore, for BEVs having the vehicle body 150, alternative mounting arrangements are required to secure and support the lower portion 192 of the garnish 190.

With reference to FIG. 3, a bracket 210 is secured to the lower frame component 156 and is spaced forward of the outer side panel 198 of the A-pillar 152. The lower portion 192 of the garnish 190 is secured to the bracket 210 via a first fastener 212. The first fastener 212 is extended through a hole 216 in the lower portion 192 and fastened to the bracket 210. As indicated, the garnish 190 is connected to the outer side panel 198 via at least one second fastener configured differently than the first fastener. As depicted, the first fastener 212 is a bolt, and the at least one second fastener is the clips 204 provided on the underside of the garnish 190 that are secured in the mounting features 200. The clips 204 are spaced from the bolt 212 in a length direction of the garnish 190. With the use of the clips 204, the garnish 190 is installed on the outer side panel 198 normal to a clip axis, meaning that the garnish 190 with the clips 204 once inserted into the openings 202 of the mounting features 200 is then moved in one of the longitudinal direction and the width direction.

According to one aspect of the present disclosure, the bracket 210 is a hinge bracket for an associated vehicle hood mounted on the platform 166. Therefore, the lower portion 192 of the garnish 190 can be secured and supported without the need for additional components mounted to the lower frame component 156. The hinge bracket 210 includes a body 220 having a forward end 222 and a rearward end 224 relative to the longitudinal direction, and an upper edge 226. When mounted on the platform 166, the body 220 is outwardly spaced from the inward vertical wall 168 and the rearward end 224 is located adjacent the rearward vertical wall 172. An auxiliary tab 230 is extended from the body 220 in one of the width direction and the height direction of the vehicle body. In FIG. 3, the auxiliary tab 230 is located closer to the forward end 222 than the rearward end 224 and is extended from the body 220 in the height direction so that the auxiliary tab 230 projects above the upper edge 226. The auxiliary tab 230 includes a hole 232 for the bolt 212, which can be threaded.

The lower portion 192 of the garnish 190 includes a flange 236 having the hole 216 for the bolt 212. The flange 236 defines an extension of an inner side wall 238 of the lower portion 192 of the garnish 190 and is extended from a lower peripheral edge 240 of the lower portion 192. In the depicted embodiment, the garnish 190 includes an outer member 244 (shown in transparent) and an inner member 246 secured to an underside of the outer member. The clips 204 are located on the inner member 246. The inner side wall 238 is part of the inner member 246 such that flange is extended from the inner member. With the auxiliary tab 230 extended from the body 220 in the height direction, the flange 236 is oriented in the same direction, and the bolt 212 is extended through the hole 216 in the flange and fastened to the auxiliary tab 230 in the width direction after the garnish 190 is clipped to the outer side panel 198 of the A-pillar 152.

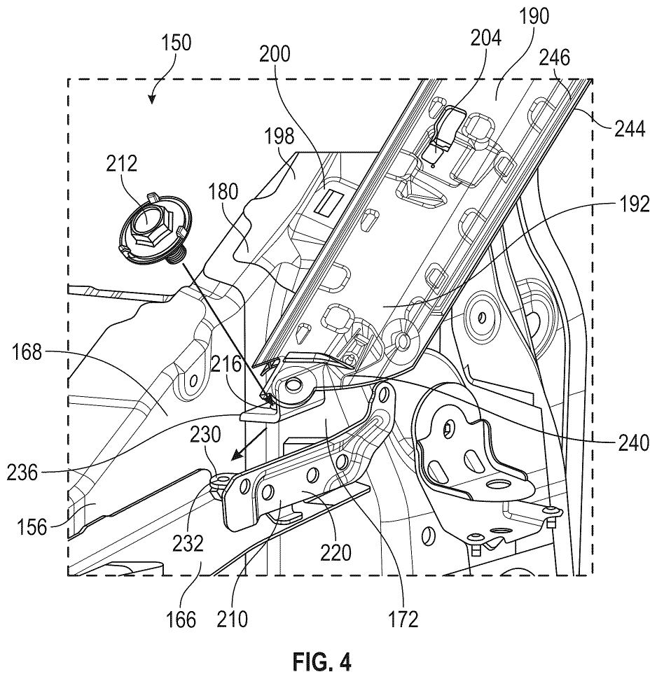

FIG. 4 shows an alternative orientation of the auxiliary tab 230, where the auxiliary tab 230 is extended from the body 220 of the hinge bracket 210 in the width direction of the vehicle body. The flange 236 is correspondingly extended from the lower peripheral edge 240 of the lower portion 192 also in the width direction. The bolt 212 is extended through the hole 216 in the flange 236 and fastened to the auxiliary tab 230 in the height direction after the garnish 190 is clipped to the outer side panel 198 of the A-pillar 152.

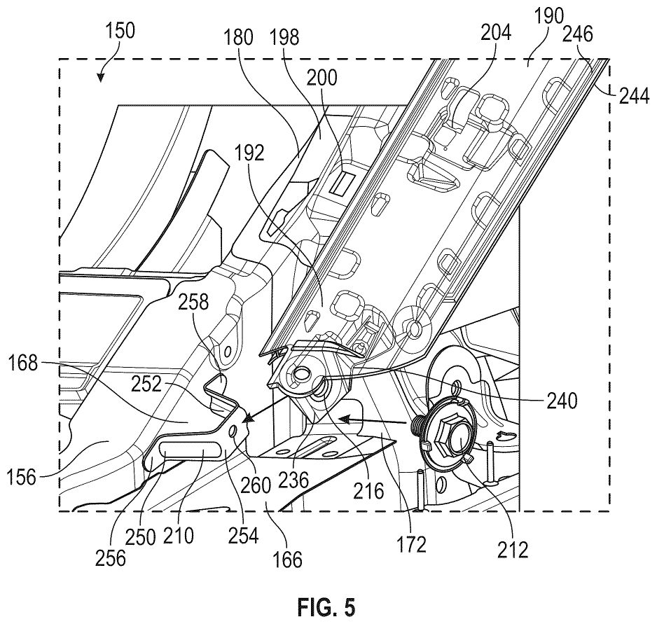

FIG. 5 depicts another aspect of the present disclosure where the bracket 210 is not a hinge bracket but is a separate part secured, for example, to the inward vertical wall 168 of the lower frame component 156. In this aspect, a hinge bracket for an associated vehicle hood is still mounted to the platform 166 similar to FIG. 3, and the bracket 210 is forward of the hinge bracket in the longitudinal direction of the vehicle body. The bracket 210 is substantially U-shaped with opposed sidewalls 250, 252 and a base wall 254 interconnecting the sidewalls. The sidewalls 250, 252 have respective mounting tabs 256, 258 that are attached (e.g., welded) to the inward vertical wall 168. The base wall 254 includes a hole 260 for the bolt 212, which can be threaded. With the bracket 210 extended from the inward vertical wall 168, the base wall 254 is oriented in the height direction of the vehicle body. The flange 236 extended from the lower peripheral edge 240 of the lower portion 192 also in the height direction, and the bolt 212 is extended through the hole 216 in the flange and fastened to the bracket 210 in the width direction after the garnish 190 is clipped to the outer side panel 198 of the A-pillar 152.

The present disclosure further teaches a method of assembling the garnish 190 to the vehicle body 150 of a BEV including the A-pillar 152 and the lower frame component 156. The exemplary method comprises attaching the bracket 210 to the lower frame component 156 forward of the A-pillar 152 in the longitudinal direction of the vehicle body 150; positioning the clip 204 in the clip housing 206 provided on an inner surface of the garnish 190; attaching the clip 204 to the A-pillar 152, wherein the garnish 190 is installed normal to a clip axis; and fastening the lower portion 192 of the garnish 190 to the bracket 210 via the bolt 212 installed in one of the width direction and the height direction of the vehicle body. As indicated, the bracket 210 can be part of a hinge bracket for an associated vehicle hood or can be separate from the hinge bracket, and the method includes attaching the bracket 210 to a platform of the lower frame component 156. When the bracket is part of the hinge bracket, the exemplary method includes providing the auxiliary tab 230 on the hinge bracket 210 and fastening the bolt 212 to the auxiliary tab. The exemplary method includes extending the flange 236 from the lower peripheral edge 240 of the garnish 190, and fastening the flange to the bracket 210. When the bracket 210 is not part of the hinge bracket, the exemplary method includes attaching the bracket on a vertical wall of the lower frame component 156.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle assembly comprising:
a vehicle body including an A-pillar having an outer side panel, and a lower frame component located forward of the A-pillar in a longitudinal direction of the vehicle body;
a garnish covering the A-pillar; and
a bracket secured to the lower frame component and spaced forward of the outer side panel,
wherein a lower portion of the garnish is secured to the bracket via a first fastener, the first fastener extended through a hole in the lower portion and fastened to the bracket, and the garnish is connected to the outer side panel via at least one second fastener.

2. The vehicle assembly of claim 1, wherein the bracket is part of a hinge bracket for an associated vehicle hood.

3. The vehicle assembly of claim 2, wherein the bracket includes a body and an auxiliary tab extended from the body, and the first fastener is fastened to the auxiliary tab.

4. The vehicle assembly of claim 3, wherein the auxiliary tab is extended from the body in one of a width direction and a height direction of the vehicle body.

5. The vehicle assembly of claim 1, wherein the lower portion of the garnish includes a flange extended from a lower peripheral edge of the garnish, the hole for the first fastener is provided in the flange.

6. The vehicle assembly of claim 5, wherein the garnish includes an outer member and an inner member secured to an underside of the outer member, and the flange is extended from the inner member.

7. The vehicle assembly of claim 5, wherein the flange defines an extension of an inner side wall of the lower portion of the garnish.

8. The vehicle assembly of claim 1, wherein the lower frame component includes a wall elevated in a height direction of the vehicle body, the bracket is secured to the wall.

9. The vehicle assembly of claim 1, wherein the first fastener is extended in one of a width direction and a height direction of the vehicle body through the hole in the lower portion of the garnish.

10. The vehicle assembly of claim 9, wherein the first fastener is a bolt and the second fastener is a clip spaced from the bolt in a length direction of the garnish, the clip received in a clip housing provided on the outer side panel.

11. A vehicle assembly comprising:
a vehicle body including an A-pillar having an outer side panel, and a lower frame component located forward of the A-pillar in a longitudinal direction of the vehicle body;
a garnish covering the A-pillar, a lower portion of the garnish extended at least partially over the lower frame component; and
a bracket secured to the lower frame component, the bracket is part of a hinge bracket for an associated vehicle hood,
wherein the lower portion of the garnish is secured to the bracket via a first fastener, and the garnish is connected to the outer side panel via at least one second fastener.

12. The vehicle assembly of claim 11, wherein the first fastener is extended in one of a width direction and a height direction of the vehicle body through a hole in the lower portion of the garnish and fastened to the bracket, the first fastener is a bolt.

13. The vehicle assembly of claim 12, wherein the hinge bracket includes a body and an auxiliary tab extended from the body, and the first fastener is fastened to the auxiliary tab.

14. The vehicle assembly of claim 13, wherein the auxiliary tab is extended from the body in one of the width direction and the height direction.

15. The vehicle assembly of claim 11, wherein the lower portion of the garnish includes a flange extended from a lower peripheral edge of the garnish, the flange includes a through hole for the first fastener.

16. A method of assembling a garnish to a vehicle body including an A-pillar and a lower frame component, the method comprising:
attaching a bracket to the lower frame component forward of the A-pillar in a longitudinal direction of the vehicle body;
positioning a clip in a clip housing provided on an inner surface of the garnish;
attaching the clip to the A-pillar; and
fastening a lower portion of the garnish to the bracket via a bolt installed in one of a width direction and a height direction of the vehicle body.

17. The method of claim 16, wherein the bracket is part of a hinge bracket for an associated vehicle hood, and the method includes attaching the bracket to a platform of the lower frame component.

18. The method of claim 17, including providing an auxiliary tab on the hinge bracket and fastening the bolt to the auxiliary tab.

19. The method of claim 16, including extending a flange from a lower peripheral edge of the garnish, and fastening the flange to the bracket.

20. The method of claim 16, including attaching the bracket on a vertical wall of the lower frame component.
